(19) United States
(12) Patent Application Publication
(10) Pub. No.: US 2005/0035166 A1
(43) Pub. Date: Feb. 17, 2005

(54) Universally mounted multi-purpose carrying case

(76) Inventor: Jean Kresge, Loveland, OH (US)

Correspondence Address: ROBERT R. WATERS, ESQ.;WATERS LAW OFFICE, PLLC, 633 SEVENTH STREET, HUNTINGTON, WV, 25701, US

(21) Appl. No.: 10/640,354

(22) Filed: Aug. 13, 2003

(51) Int. Cl. B62J 7/00; B62J 9/00; B62J 11/00

(52) U.S. Cl. 224/431

(57) ABSTRACT

The invention is directed to a multi-purpose carrying apparatus for transporting cargo and for mounting to a wide assortment of vehicles as well as for use as a stand-alone carrier. The apparatus features a novel mounting system for fast yet secure attachment, and interchangeable top assemblies for versatility. The apparatus has particular utility as a pet carrier. The invention may be furthered embodied in a system for light cargo transportation or delivery featuring a plurality of vehicles with standard mounting hardware and the fast and secure transfer of a cargo carrying apparatus between such vehicles in transit.

### STATEMENT REGARDING FEDERALLY SPONSORED RESEARCH OR DEVELOPMENT

Not Applicable

### FIELD OF THE INVENTION

The invention is a lightweight, multi-purpose carrying case featuring interchangeable components for versatile use and mounting on a wide assortment of travel vehicles and for transporting a wide variety of general cargo, including pets. Specifically, the carrying case of the present invention may be quickly and securely mounted to any commercially available mounting rack, by utilizing a novel mounting component. The carrier mount may be used on bicycles, mopeds, scooters, motorcycles, waverunners and automobiles providing unrestricted use between vehicles and a unique system of transportation.

### BACKGROUND OF THE INVENTION

For a society on the go, it is important to have cargo carrier devices that are convenient and versatile for a wide variety of uses. For workday or everyday use, people may find it convenient or necessary to transport a wide assortment of personal items with them throughout their day and accordingly, people spend considerable money and effort attempting to acquire handbags and carrying cases that are convenient and effective. Especially in larger cities, people often commute long distances each day to work or for shopping and other purposes, and people often find it necessary or desirable to utilize more than one mode of transportation during the course of the day. For example, people may utilize a bicycle, the subway, city buses, or automobiles in some combination to navigate their way to their destination. However, some travel bags or cargo carrying articles are designed as a cargo carrier for one specific transportation mode or vehicle. This leads to the annoying task of unloading merchandise from one carrying case to another in route or prior to departure.

In order to accommodate the carrying of luggage by bicycle, motorcycle, or other means of transportation, specialized carriers have been designed to mount directly on the vehicle. In general, such carriers include accommodations such as to couple or attach to a horizontal rack on the back of the bicycle or motorcycle, behind the seat of the user. A rail based horizontal luggage frame is somewhat standard for bicycles, motorcycles, and mopeds and most such frames feature a similar design. Luggage carriers that mount directly upon such a frame have been available for many years.

One of the earliest detachable luggage carriers for a bike is U.S. Pat. No. 4,266,703 by Litz. That patent shows a device which is claimed to be easily mounted and removed on a standard motorcycle rack. A similar arrangement is found in U.S. Pat. No. 4,588,144 by LeBaron et al. Other examples of prior art luggage racks include U.S. Pat. No. 3,625,405 to Kizar et al. and U.S. Pat. No. 5,577,646 to White. The White patent in particular is one of several prior art patents directed more specifically to a carrier for transporting a pet on a bicycle. White discloses a box-like container which is detachably mounted to a horizontal frame on the rear of the bicycle. The carrier also features a flip-up top hinged on the rear of the carrier for access. The carrier also features the appropriate handles and ventilation provisions. The White carrier suffers from the key disadvantage that due its design, it is essentially only useful for carrying a small dog, cat, or other similarly sized pets. The White apparatus has no utility for carrying general luggage and is more appropriately a single purpose article. Moreover, White can only be mounted to one specific style of bicycle rack which limits transferability, and prevents the carrier from being easily moved on and off the vehicle. Accordingly, once the pet owner reaches the bicycle destination, the pet must be removed from the carrier which stays with the bicycle. It would be much more convenient to merely snap the entire carrier from the vehicle and carry it as needed.

### SUMMARY OF THE INVENTION

The present invention is directed to a multi-use carrier assembly for safe transportation of general and live cargo. The invention may be constructed of a variety of polymers and metals that will provide the strength and stability to accommodate the size and weight requirements of general cargo. The materials selected will limit rust, fading, or color tarnish when exposed to water or UV rays and will not easily crack, bend, or break in regular use. The components of the carrier will be appropriately sized for carrying luggage on a travel vehicle, particularly bicycles, motorcycles, and mopeds. The invention features a universal mount which enables the device to be quickly and securely attached to a wide assortment of travel vehicles. The article features numerous safety locking mechanisms to enable it to be secured to the transport vehicle, and features interior latches with locks to secure the contents of the carrier such as to prevent it from being opened. A number of convenience accessories are envisioned including a carrying handle and interior tethers which enable the top of the article to be removed for ease in loading and unloading the contents. There are numerous provisions for securing mechanisms in the interior of the carrier such as car safety belt attachments, and other accessories to create separate compartments of storage, enabling more uses.

An objective of the present invention is to create a multi-use cargo carrier apparatus utilizing a universal mount which enables the article to be quickly moved from a vehicle or between vehicles without specific rack restrictions.

Another objective of the present invention is to construct a multi-purpose cargo carrier which is also suitable for safely and comfortably loading, unloading and transporting small pets, particularly a small dog, a cat or other pets of similar size.

Another objective of the present invention is to construct a multi-purpose carrier assembly featuring an aerodynamic design such as to not interfere with the aerodynamic operation of a bicycle, motorcycle, or moped and to provide a mounting device capable of withstanding sudden lateral movements, in the event of a sudden stop or sideways motion.

Another objective of the present invention is to construct a multi-purpose carrier assembly which is durable and with provisions to keep weather from damaging the contents. At the same time, the assembly must be lightweight enough to enable it to be transported easily.

Another objective of the present invention is to construct a multi-purpose carrier assembly which is adaptable as a general carrying case when not used in conjunction with a vehicle, and capable of being locked to deter theft when left unattended by the owner. The carrier can also be shipped as luggage when not used in conjunction with a vehicle.

Another objective of the present invention is to construct a multi-use carrier assembly which is easy to clean, and may be disassembled without tools for ease in cleaning.

Another objective of the present invention is to construct a multi-use carrier assembly which is economical to produce, and may be efficiently and effectively mass produced.

As discussed above, the method and device of the present invention overcomes the disadvantages inherent in prior art methods and devices. In this respect, before explaining at least one embodiment of the invention in detail, it is to be understood that the invention is not limited in its application to the details of construction and to the arrangement of the components set forth in the following description or illustrated in the drawings. The invention is capable of other embodiments and of being practiced and carried out in various ways. Also, it is to be understood that the phraseology and terminology employed herein are for the purposes of description and should not be regarded as limiting.

Accordingly, those skilled in the art will appreciate that the conception upon which this invention is based may readily be utilized as the basis for other structures, methods, and systems for carrying out the purposes of the present invention. It is important, therefore, that the specification be regarded as including such equivalent constructions insofar as they do not depart from the spirit of the present invention.

Furthermore, the purpose of the foregoing abstract is to enable the U.S. Patent and Trademark Office and the public generally, and especially including the practitioners in the art who are not familiar with patent or legal terms or phraseology, to determine quickly from a cursory inspection, the nature and essence of the technical disclosure of the application. The Abstract is neither intended to define the invention of the application nor is it intended to be limiting to the scope of the invention in any way.

### BRIEF DESCRIPTION OF THE DRAWINGS

Additional utility and features of this invention will be become more fully apparent to those skilled in the art by reference to the following drawings, wherein all components are designated by like numerals and described more specifically.

FIG. 1 is an exploded perspective view of the preferred embodiment of the present invention showing each of the primary components and the means by which they are assembled.

FIG. 2 is an exploded perspective view of the mounting elements viewed from the top side in a preferred embodiment.

FIG. 3 is an exploded perspective view of the mounting elements viewed from the bottom side in a preferred embodiment.

FIG. 4 is a perspective view of a preferred embodiment of the present invention in use as a pet carrier mounted to a bicycle.

FIG. 5 is a perspective view of a preferred embodiment of the present invention in use as a beverage cooler mounted to a bicycle.

### DETAILED DESCRIPTION

The multi-faceted carrying device of the present invention may be constructed in a variety of forms utilizing a variety of materials. The apparatus may also be scaled up or down in physical size in order to accommodate style and utility needs of the user, and/or sized to more appropriately and aesthetically merge with the vehicle upon which it is mounted. The preferred embodiments discussed herein have particular utility in achieving the purposes outlined above while also presenting an economical and versatile apparatus for consumer appeal.

One particularly useful embodiment is the use of the invention as a pet carrier. One of the key purposes of the present invention is to develop a carrier that, when used as a pet carrier, addresses numerous safety-related shortcomings of prior art pet carriers used in conjunction with a moving vehicle. With most conventional pet carriers, little or no attention is put on safety of the pet during movement, and safety features on most devices are generally limited to providing slots for ventilation. However, it must be considered that it is possible that an accident could occur such that the carrier would be struck or the vehicle capsized. The present invention is constructed of solid and durable structural members that will enclose the pet and generally withstand a greater blunt force than many prior art devices.

Safety of a transported pet is also addressed by the use of larger pop-in ventilation panels. Larger ventilation panels generally result in an improved airflow with less likelihood of heat related problems for the pet. In addition, the nature of the ventilation panels is such that all body parts of the pet are fully retained inside the apparatus during travel. Some contemporary devices provide the feature that the pet can actually stick a body part, such as a dog's nose or head, out of the carrier. For a stationary device, that may be fine. However, since the carrier of the present invention is designed for vehicular travel purposes, it is important that all body parts be retained inside the apparatus, while still providing appropriate ventilation.

Another feature of this preferred embodiment that is closely related to safety is the goal of providing a pet carrier that adds comfort for the pet while improving safety. The overall confinement area of the present invention achieves that goal. In one preferred embodiment, the carrier features a generally round base with a smaller enclosed “head room area”. In the overall confinement area, there is expansive space that allows the pet of suggested dimensions to either curl-up, lay down, or sit up in a begging position. With some conventional carriers, only a sitting position is possible due to the construction of the case. The restrictive space designed in the present invention reduces in width as the height increases, thus limiting the lateral movement of the pet in the event of a sudden stop movement or any sideways movement or combination thereof.

Another feature of this preferred embodiment with particular utility is the ease with which a pet may be inserted in the carrier. Most conventional carriers feature a hinged door, within which the owner inserts a pet by backing the pet into the carrier. Many times, a pet will resist being placed in the carrier and will attempt to claw or kick during insertion. Such an exercise is a significant nuisance for the pet owner as well as a possible injury source for the pet and the owner. With the present invention, the entire top or dome of the carrier is removed such that insertion of the pet is significantly easier because the whole carrier base is exposed. Not only can the pet be loaded and unloaded more quickly, the hassle and injury potential of the exercise is greatly reduced.

Of course, prior art carriers generally do not include features that accent the quick and effective transformation of the device from a pet carrier to a general-purpose carrier, as does the present device. The versatility of use is achieved by the assembly of a unique collection of interlocking parts as shown herein.

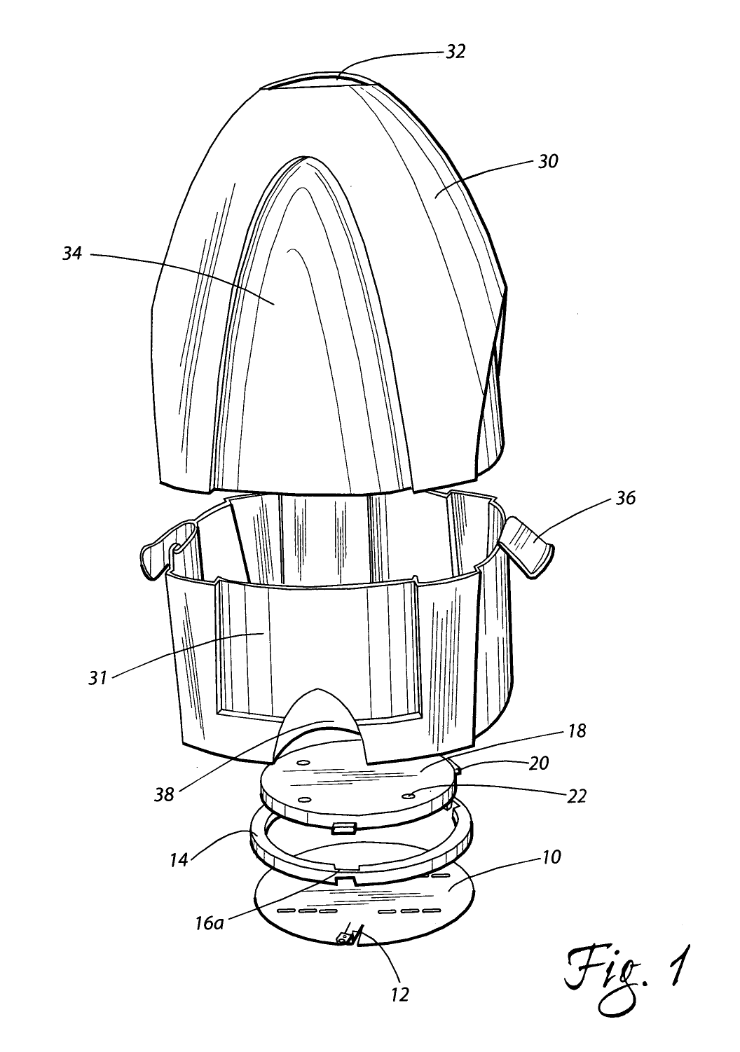

Referring to FIG. 1, the luggage apparatus is comprised essentially of a number of components that are arranged vertically into a lockable but easily removable carrying case. The apparatus is comprised first of a surface mounting plate 10 which is generally flat and may be constructed of a variety of materials including most commercially feasible metals such as aluminum and steel, as well as preferably, plastic. In general, surface mounting plate 10 serves the purpose of anchoring the apparatus to a vehicle rack or other such surface. As shown in FIG. 1, surface mounting plate 10 is generally round although it would not have to be, and features an assortment of apertures arranged in grouped patterns, the drawing showing two parallel groups of slotted apertures. The apertures will preferably be linear slots providing for flexibility in customizing the connection of the apparatus upon the vehicle. The slot configurations will be pre-drilled to fit the most popular standard mounting racks for most travel vehicles. The underside of mounting plate 10 will be adapted such as to accept a variety of commercially available fastening means including but not limited to j-bolts or u-bolts, nylon straps, buckled straps or the equivalent. In practice, bolts may be placed through the apertures to mount the surface mounting plate to a vehicle such as a bicycle rack or motorcycle rack.

As also shown in FIG. 1, the apparatus is further comprised of ring 14. Ring 14 is generally constructed of a metallic or polymeric material and is preferably formed as an integrated member with surface mounting plate 10. In FIG. 1, surface mounting plate 10 and ring 14 are shown separated for conceptual clarity only, as the preferred embodiment would utilize an integrated mounting plate/ring assembly which cannot be separated by the end user. The overall purpose of ring 14 is to provide a surface adjacent mounting plate 10 which will feature anchoring notches for securing the remainder of the apparatus to the mounting plate 10.

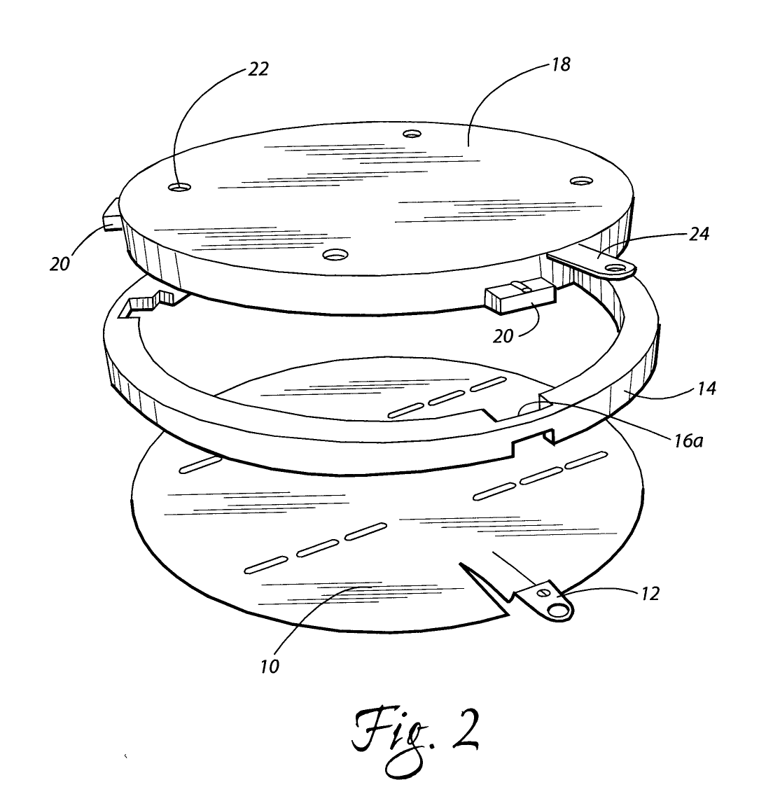

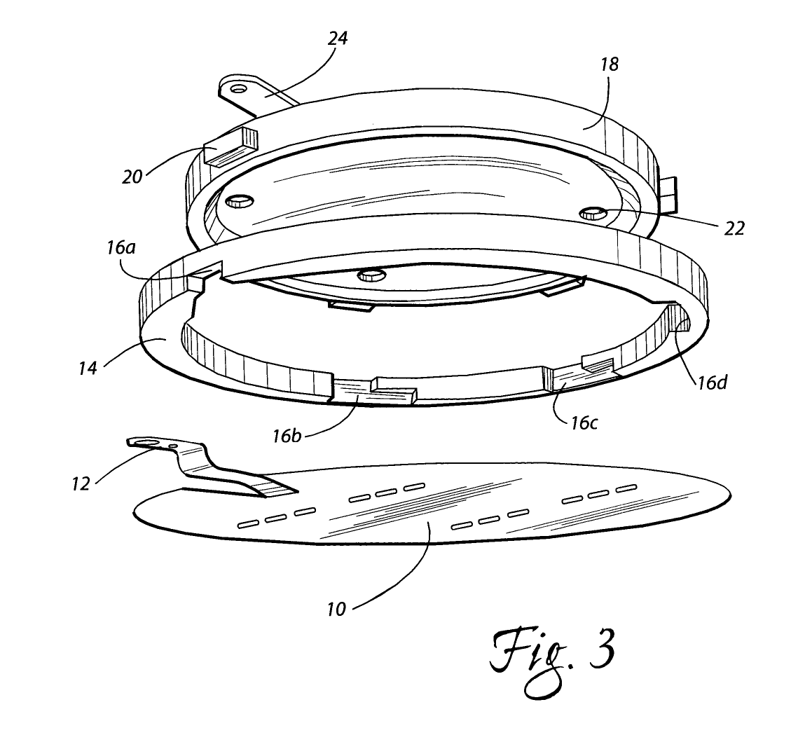

FIGS. 2 and 3 show an enlarged view of ring 14 along with the other anchoring elements in exploded perspective views. As particularly shown in FIG. 3, ring 14 includes four distinct and specifically placed slots designated 16a, 16b, 16c, and 16d. Slot 16a serves as the main alignment slot for alignment of the sections of the apparatus and is physically slightly larger than the other three slots. It is also important to note that the four slots are not equidistantly spaced along the inside perimeter of ring 14. Rather, locking slots 16b, 16c, and 16d are more closely spaced from each other somewhat opposite of main alignment slot 16a. It is important that the orientation of the locking slots be unique or asymmetrical such that the elements are forced to be aligned a certain way when the apparatus is assembled. Otherwise, the locking tabs may not appropriately align and the device cannot be secured. Although the specific location of locking slots 16b, 16c, and 16d may vary, they must be uniquely configured in order to insure that this purpose is served. Within the channel of each slot are recessed openings specifically designed to accept the raised peg on the mounting plate tab when rotated into position. A secure position is reached when a distinct sound is made when the mounting plate peg inserts into the recessed opening in the ring.

Particular utility in locking and maintaining the apparatus is found by the operation of pod mounting plate 18 as shown in FIG. 1. Pod mounting plate 18 is a generally flat, round plate of uniform thickness, which is sized to couple with ring 14 to lock therein. Mounting plate 18 includes a series of male ring tabs 20 located along the outside periphery of pod mounting plate 18. In operation, mounting plate 18 is placed upon ring 14 and turned clockwise such that male ring tabs 20 couple with female ring slots 16 located on the inside periphery of ring 14. Upon insertion of male ring tabs 20 through female slots 16, the mounting plate 18 may be turned and thereby locked within the periphery of ring 14. As further shown in FIG. 1, mounting plate 18 may also optionally include a series of one or more mounting holes 22 as shown.

Also shown in FIGS. 1-3, surface mounting plate 10 includes a steel spring lever 12 which generally serves as the securing and locking element for retaining the apparatus together in a quick but secure manner. Pushing down on lever 12 allows for rotation of the mounting plate 18 and for complete removal of mounting plate 18 from ring plate 14. The lever serves to block the main alignment channel when the tabs are secured into place, stopping the mounting plate 18 from rotating freely. Steel spring lever 12 may also preferably include an aperture of its own near the end of the lever for placement of the padlock or other locking means in order to aid in preventing the apparatus from being stolen.

FIG. 1 shows that mounting plate 18 features a locking tab 55 which is sized and positioned to compliment steel spring lever 12. Apertures in each of lever 12 and locking tab 55 are sized to accommodate the insertion of a padlock or other locking instrument through both apertures to further secure the apparatus to the mounting plate.

Each of the tabs has securing pegs that couple with recessed openings in the ring when rotated into a secure position. To separate the components, one must twist the components in a counterclockwise position with enough force to overcome the securing pegs within each slot.

The prime cargo base of the apparatus is shown as item 31 in FIG. 1. The base not only provides the cargo holding capacity for the apparatus but also gives the apparatus aesthetic form and clarity. Base 31 includes a recessed area 38 as shown in FIG. 1. Recessed area 38 serves the purpose of enabling hand access to the lock and mounting plate such that the user can remove the padlock, push down the steel spring lever 12, and twist the respective plates with enough force in a counterclockwise motion for disengagement of the apparatus from the surface mounting plate.

Base 31 is generally made of durable plastic or other polymeric material. Base 31 attaches to top 30 to define the cargo compartment of the device, and may be connected by any number of conventional attachment means. In a preferred embodiment, a water resistant cargo compartment is formed in that the base 31 is solid and connects with the top 30 by a water tight tongue and groove means, and could even feature a rubber gasket or seal between base 31 and top 30. Base 31 further features four countersunk mounting screws (not shown) located in the interior of the base. The screws are used to removably mount base 31 to mounting plate 18. Optionally, the screws may be sealed or watertight expansion screws may be used such as to create a generally liquid tight base. This function may be very important, for example, if support base 31 is used to transport a liquid. In one particularly useful embodiment, base 31 may be filled with ice and canned drinks and serve as a portable cooler. As a further option, a lid may be placed directly onto base 31 and attached such as to complete a flat top cooler assembly. The exterior of base 31 features at its top, two hinged latches 36 on each side to connect the top to base 31 and to accommodate interchangeable tops.

The interior of base 31 may also feature tethers made of a stretchable and durable material that will be used to connect the top to the base, specifically when the top is unlatched from the base 31. The tethers (not shown in any drawings) allow the user to shift the top off the back end of the base 31 for quick fastening without completely removing the top from the rest of the apparatus. The interior of the base may also have numerous anchoring points and securing mechanisms to secure cargo in compartments or to fasten the base to an exterior mounting device.

When removal of top 30 is desired, the user will operate the locking safety latches 36 as generally indicated in FIG. 1. The latches may be padlocked or otherwise key-locked in order to prevent tampering or access to the cargo. The apparatus also features one or more removable front and back panels 34 as shown. The front and back panels are open windows to provide pet ventilation and removable panels may be replaced if desired with similarly sized and arranged adjustable louvers, mesh or screen panels, or solid panels to create various states of closure. This may have particular utility in the transportation of an animal, when additional protection is required. When the cargo transported is general cargo, however, it may be more desirable to use a solid panel as shown by numeral 34 in order to provide weather protection for said merchandise. The apparatus may further include a handle 32 as shown in FIG. 1.

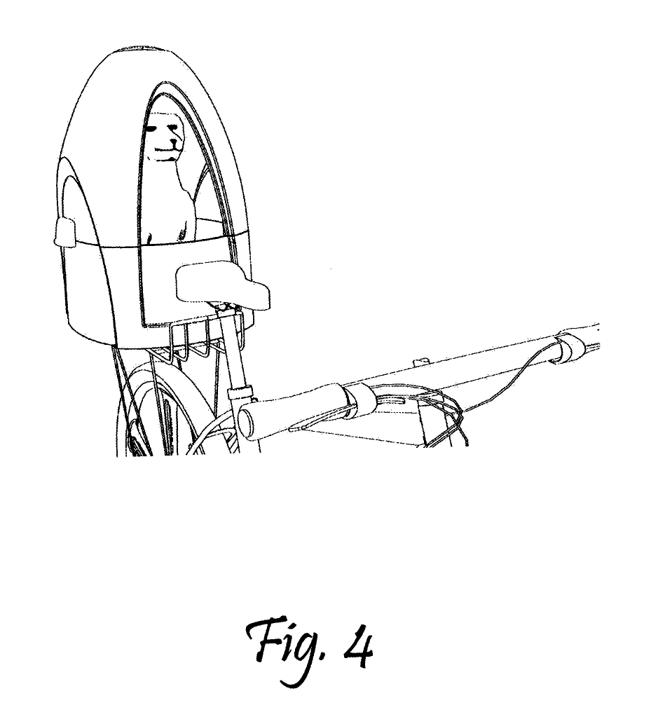

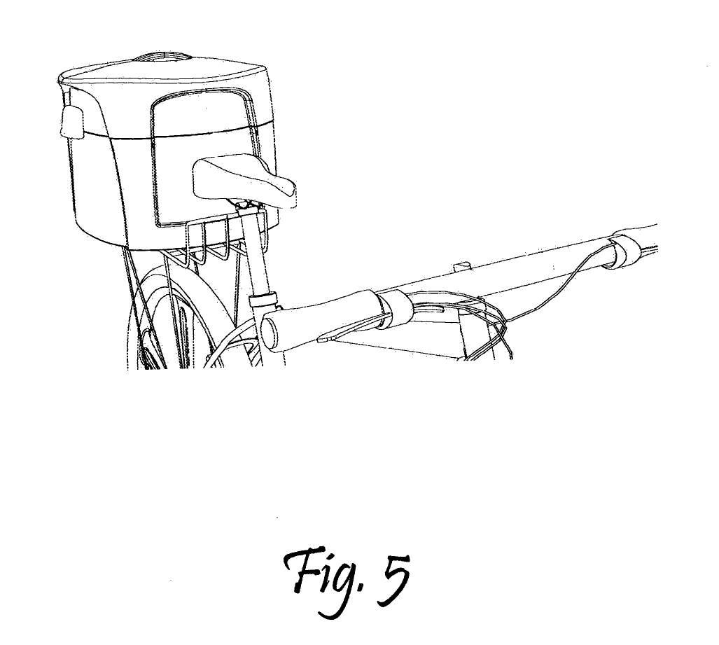

FIGS. 4 and 5 show overall embodiments of the present invention in use, mounted on a bicycle. FIG. 4 shows the apparatus in use as a pet carrier, with a dog placed in the carrier. As described earlier, the dog is fully contained within the carrier and the carrier features sufficient space for the animal to be reasonably comfortable. FIG. 5 shows the carrier in use as a flat top luggage carrier. This design is also optimal for use as a beverage cooler as described above.

The cargo carrying apparatus of the present invention may also be employed in a transportation system utilizing multiple vehicles. In such a system, each vehicle includes a standardized mounting plate 18 as described and disclosed above. The cargo carrying apparatus may be quickly and securely transferred between vehicles as needed to effect a rapid transfer of the cargo without removing the cargo from the carrying apparatus.

The cargo transportation system of the present invention may take a variety of arrangements. By way of an example, the system could take the form of a bicycle-based urban delivery system. The system would be comprised of a fleet of bicycles operated by delivery drivers and each bicycle would be permanently outfitted with the standard mounting plate arrangement. In this embodiment, each driver may have a geographic region within which he or she serves to deliver light cargo or packages. As a package is needed for delivery in another part of town, the cargo may be placed in the standardized carrying case of the present invention and transferred from bicycle to bicycle from one geographic region to another. In some respects, the delivery system is akin to the pony express mail system of the 19^{th} century. However, one of the drawbacks to a multi-vehicle courier service is downtime associated with loading and unloading the payload between vehicles. The present invention addresses that need through the use of a quick and efficient mounting system for each vehicle, yielding considerable savings in transfer time, and hence, financial savings for a package delivery operation.

Another embodiment of the cargo transportation system of the present invention can be seen in the operation of a delivery service for moving pets to a veterinarian, pet store, etc. in an urban environment. The cargo carrying apparatus may be quickly transferred between vehicles without removing the animal from the apparatus and hence, the animal may be quickly transported with minimal physical handling of the animal by transportation personnel.

Another prime example of a commercial embodiment of the cargo transportation system of the present invention is a pizza or food delivery system in an urban setting. The cargo-carrying base of the invention may be formed in the general shape of a holder for depositing a pizza box, for example. A plurality of bicycles or other light vehicles may be fitted with mounting brackets such as to receive the pizza enclosure upon said vehicle. Accordingly, a pizza is readied at the pizza shop, the box is placed into an appropriately sized insulated carrier, and mounted onto a bicycle for delivery purposes. As such, the pizza may be rapidly delivered by the bicycle carrier with a minimum of a handling and minimizing the delay time in securing and removing the pizza from the vehicle. A wide assortment of other embodiments are also available for any type of food, medicine, or other light cargo delivery system in which security of the merchandise is important and speed of delivery is important.

1) A portable cargo carrying apparatus comprised of:
a) a mounting plate consisting of a top surface and a bottom surface, said bottom surface adapted to be affixed to a surface of a vehicle;
b) a base member comprising a bottom surface, one or more side walls and an open top thereby defining a cargo carrying compartment, and wherein the outside bottom surface of said base member is adapted to removably couple with said mounting plate; and
c) a top member adapted to removably couple with said base member along the top periphery of said cargo carrying compartment to define an enclosure for securing cargo.

2) The apparatus of claim 1 wherein said mounting plate is adapted for permanent attachment to a luggage rack for a vehicle.

3) The apparatus of claim 2 wherein said apparatus is further comprised of a ring permanently affixed to said top surface of said mounting plate, said ring featuring an internal and external circumferential surface, and wherein said internal circumferential surface features a series of two or more notches formed therein.

4) The apparatus of claim 3 wherein said two or more notches formed in the internal circumferential surface of said ring are further defined such that each notch features two distinct portions as follows:
a) a top portion of said notch having a certain area along the top inside circumference of said ring and extending below to approximately one half of the thickness of said ring, and
b) a bottom portion of said notch having a second and larger area along the bottom inside circumference of said ring such that said top and bottom notch portions are adjacent and contiguous to each other defining a notch wherein the top side of each notch of said ring is smaller that the bottom portion of said notch, defining an overhang portion of each such notch along the top side of said ring with respect to the bottom side of said ring.

5) The apparatus of claim 4 wherein said base is further defined such that said outside bottom surface features a base plate attached or integrally formed therein, and wherein the outside circumference of said base plate rests snugly within the circumference of said ring and wherein said base plate features one or more tabs disposed along the outside periphery of said base plate, said tabs arranged to couple with said notches in said ring such as to enable such tabs to lock said ring and said plate together.

6) The apparatus of claim 5 wherein said tabs along the outside periphery of said base plate integrally formed within said base plate are sized to just fit into said top portions of said notches in said ring, and wherein upon rotation of said base with respect to said ring, said tabs are moved to underneath said overhang portions of said notches, thereby locking said base with respect to said ring.

7) The apparatus of claim 5 wherein said mounting plate is further defined by a spring lever oriented below one or more of said notches in said ring, and arranged such as to bias upward into the bottom portion of said notch such that once said tabs are oriented into said rotated position, the movement of said base with respect to said ring is prevented unless said spring lever is depressed downward.

8) The apparatus of claim 7 wherein said base plate is further defined by a locking tab with an aperture disposed therein and said spring lever is further defined by an aperture in the end of said spring lever arranged such that both of said apertures are disposed above each other when said base is assembled onto said mounting ring and moved to said rotated position, for inclusion of a padlock or other locking means through said apertures.

9) The apparatus of claim 1 wherein said cargo carrying compartment of said base is further defined as including a watertight interior region.

10) The apparatus of claim 1 wherein said top member is a generally flat horizontal panel.

11) The apparatus of claim 1 wherein said apparatus is further defined by one or more tethers disposed within said cargo carrying compartment for securing said cargo within said compartment.

12) The apparatus of claim 1 wherein said top member is generally domed in shape.

13) The apparatus of claim 12 wherein said domed top features one or more removable panels within the side of said dome which may be selectively removed.

14) The apparatus of claim 13 wherein screened inserts may alternatively be placed into said one or more removable panel locations.

15) A portable pet carrier comprised of:
a) a mounting plate consisting of a top surface and a bottom surface, said bottom surface adapted to be permanently affixed to a surface of a vehicle;
b) a base member comprising a bottom surface, one or more side walls and an open top thereby defining a cargo carrying compartment, and wherein the outside bottom surface of said base member is adapted to removably couple with said mounting plate; and
c) a top member adapted to removably couple with said base member along the top periphery of said cargo carrying compartment to define an enclosure for securing cargo.

16) The portable pet carrier of claim 15 wherein said apparatus is further comprised of a ring permanently affixed to said top surface of said mounting plate, said ring featuring an internal and external circumferential surface, and wherein said internal circumferential surface features a series of two or more notches formed therein.

17) The portable pet carrier of claim 16 wherein said two or more notches formed in the internal circumferential surface of said ring are further defined such that each notch features two distinct portions as follows:
a) a top portion of said notch having a certain area along the top inside circumference of said ring and extending below to approximately one half of the thickness of said ring, and
b) a bottom portion of said notch having a second and larger area along the bottom inside circumference of said ring such that said top and bottom notch portions are adjacent and contiguous to each other defining a notch wherein the top side of each notch of said ring is smaller that the bottom portion of said notch, defining an overhang portion of each such notch along the top side of said ring with respect to the bottom side of said ring.

18) The portable pet carrier of claim 17 wherein said base is further defined such that said outside bottom surface features a base plate attached or integrally formed therein, and wherein the outside circumference of said base plate rests snugly within the circumference of said ring and wherein said base plate features one or more tabs disposed along the outside periphery of said base plate, said tabs arranged to couple with said notches in said ring such as to enable such tabs to lock said ring and said plate together.

19) The portable pet carrier of claim 18 wherein said tabs along the outside periphery of said base plate are sized to just fit into said top portions of said notches in said ring, and wherein upon rotation of said base with respect to said ring, said tabs are moved to underneath said overhang portions of said notches, thereby locking said base with respect to said ring.

20) The portable pet carrier of claim 18 wherein said mounting plate is further defined by a spring lever oriented below one or more of said notches in said ring, and arranged such as to bias upward into the bottom portion of said notch such that once said tabs are oriented into said rotated position, the movement of said base with respect to said ring is prevented unless said spring lever is depressed downward.

21) The portable pet carrier of claim 20 wherein said base plate is further defined by a locking tab with an aperture disposed therein and said spring lever is further defined by an aperture in the end of said spring lever arranged such that both of said apertures are disposed above each other when said base is assembled onto said mounting ring and moved to said rotated position, for inclusion of a padlock or other locking means through said apertures.

22) The portable pet carrier of claim 15 wherein said top member is generally domed in shape, and features one or more removable screened panels.

23) A cargo transportation system comprising:
a) a plurality of vehicles operated to transmit said cargo; and
b) a plurality of portable cargo carrying apparatuses, wherein each apparatus is comprised of:
i) a mounting plate consisting of a top surface and a bottom surface, said bottom surface adapted to be affixed to a surface of a vehicle;
ii) a base member comprising a bottom surface, one or more side walls and an open top thereby defining a cargo carrying compartment, and wherein the outside bottom surface of said base member is adapted to removably couple with said mounting plate; and
iii) a top member adapted to removably couple with said base member along the top periphery of said cargo carrying compartment to define an enclosure for securing cargo;
c) wherein said base members and top members may be freely and quickly relocated between said plurality of vehicles to effect a quick transfer of cargo from vehicle to vehicle.

24) The cargo transportation system of claim 23 wherein each of said apparatus is further comprised of a ring permanently affixed to said top surface of said mounting plate, said ring featuring an internal and external circumferential surface, and wherein said internal circumferential surface features a series of two or more notches formed therein.

25) The cargo transportation system of claim 24 wherein said two or more notches formed in the internal circumferential surface of each said ring is further defined such that each notch features two distinct portions as follows:
a) a top portion of said notch having a certain area along the top inside circumference of said ring and extending below to approximately one half of the thickness of said ring, and
b) a bottom portion of said notch having a second and larger area along the bottom inside circumference of said ring such that said top and bottom notch portions are adjacent and contiguous to each other defining a notch wherein the top side of each notch of said ring is smaller that the bottom portion of said notch, defining an overhang portion of each such notch along the top side of said ring with respect to the bottom side of said ring. the top interior portion of said ring.

26) The cargo transportation system of claim 25 wherein each base of each said apparatus is further defined such that said outside bottom surface features a base plate attached or integrally formed therein, and wherein the outside circumference of said base plate rests snugly within the circumference of said ring and wherein said base plate features one or more tabs disposed along the outside periphery of said base plate, said tabs arranged to couple with said notches in said ring such as to enable such tabs to lock said ring and said plate together.

27) The cargo transportation system of claim 26 wherein said tabs along the outside periphery of each of said base plates is sized to just fit into said top portions of said notches in said ring, and wherein upon rotation of said base with respect to said ring, said tabs are moved to underneath said overhang portions of said notches, thereby locking said base with respect to said ring.

28) The cargo transportation system of claim 26 wherein said mounting plates are further defined by a spring lever oriented below one or more of said notches in said ring, and arranged such as to bias upward into the bottom portion of said notch such that once said tabs are oriented into said rotated position, the movement of said base with respect to said ring is prevented unless said spring lever is depressed downward.

29) The cargo transportation system of claim 27 wherein said base plates are further defined by a locking tab with an aperture disposed therein and said spring lever is further defined by an aperture in the end of said spring lever arranged such that both of said apertures are disposed above each other when said base is assembled onto said mounting ring and moved to said rotated position, for inclusion of a padlock or other locking means through said apertures.

30) The cargo transportation system of claim 23 wherein each of said cargo carrying compartment defined by said base and said top may be removed from each vehicle and used as a conventional carrying case for cargo.
